(19) United States
(12) Patent Application Publication
(10) Pub. No.: US 2008/0270890 A1
(43) Pub. Date: Oct. 30, 2008

(54) FORMATTING AND COMPRESSION OF CONTENT DATA

(76) Inventor: Donald S. Stern, Lexington, KY (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/739,638

(22) Filed: Apr. 24, 2007

(51) Int. Cl. G06F 17/00; G06F 15/00; G06F 17/20; G06F 17/30; G06F 7/00

(52) U.S. Cl. 715/239; 715/252; 707/101; 707/102; 707/E17.006

(57) ABSTRACT

Embodiments a method and system for reducing the quantity of data used to reproduce rich content formatted for display, such as a web page, on a target device, by translating text based formatting instructions into a numerical based formatting instruction format, resizing any visual content data appropriately for display on the target device screen, and compressing the translated and resized content data.

### CROSS-REFERENCE TO RELATED APPLICATIONS

This application is one of a set of related U.S. applications, the set including: METHOD AND SYSTEM FOR LINKING TO CONTENT AND SERVICES FOR A COMMUNICATION DEVICE (Atty. Docket No. GHACK19.001AUS, filed on even date herewith); and MESSAGE PUSH WITH PULL OF INFORMATION TO A COMMUNICATIONS COMPUTING DEVICE (Atty. Docket No. GHACK19.003AUS, filed on even date herewith) all of which are incorporated by reference in their entirety.

### BACKGROUND OF THE INVENTION

1. Field of the Invention

The technical field of the invention is formatting and compression of data. An example of an application of the invention is formatting and compression of data to optimize the data for transmission using a wireless network.

2. Description of the Related Art

On the Internet most designers currently do not consider the size of the content data, such as graphics, text, animation, video and audio data, on their web pages believing that most users access the web pages via high speed broadband Internet connections, for example DSL or T1 connected connections and low speed dialup connections are increasingly rare.

However, in the case of devices such as mobile phones, connections are typically slower than broadband internet connections. This is due to a number of factors, such as bandwidth restrictions, network resource limitations, device limitations and incumbent wireless network protocols. For example, using a GSM 2.5 GPRS connection the data transfer rate is similar to that of a 9,600 baud modem. This slow data channel limits the user in quickly accessing data.

Currently the cellular industry is attempting to meet their customers' demands for faster data transfer by installing higher speed data connection network capabilities such as 3G, EDGE, UTMS, HSDPA and other systems that provide higher data access speeds. This upgrade of the networks requires substantial expenditure on network infrastructure by the cellular network carriers and also mobile users as it is necessary for users to purchase new mobile handsets and devices that are compatible with the new higher speed networks.

Another problem for cellular users is that the development of the data infrastructure between the Internet and cellular base stations (cell towers) currently lags behind the network infrastructure development such that even with a high speed connection between the handset and the tower the connection to the Internet is lacking.

A second problem for the majority of mobile devices is that once data is delivered to the mobile device, even in formats designed for mobile devices such as the existing MIDP, WAP, XML and MHTML standards, formats are to large to be easily programmed to fit on small slow processors with limited memory space. There is currently a lack of compatibility between browsing and web page translators used on different mobile devices, which inhibits the ability for a web designer to control or even test how the content will be displayed on the mobile device. Further not all browsers or translators are compatible with all the existing formats. The result of this is that most times a HTML WEB page or WAP page containing XML formatted content will not appear correctly formatted on the screen of mobile devices.

The third problem in current mobile devices is that unlike the PC industry where only a few different screen sizes are used, there is great variation in the screen sizes, proportions, pixel counts and resolutions of screens used for mobile devices. Today when a WEB page designer designs a page they use an 800×640 or a 1024×768 pixel count as the base page. When displayed on larger formatted screens the data is surrounded by white space. Currently the problem of the great variation in mobile device screen size, pixel count, resolution and proportions is ignored by wed site designers with the result that displays can not handle the data that is to be displayed. Also displaying web pages on different size screens can cause the aspect ratio of the web page and elements on the page to change. Images that are displayed on non-computer screens can be distorted when the screen is smaller or larger or with different ratios of horizontal and vertical dimensions from the original image. This distortion effect typically occurs when resizing images for small cellular phone screens or for large HDTV screens that are designed for TV programs and not web site displays.

### SUMMARY OF THE INVENTION

According to one aspect there is provided a method of optimizing rich content for transmission and reproduction on a target device, comprising the steps of:

obtaining content element data and formatting instructions for each rich content element;

translating the formatting instructions of each rich content element into small footprint equivalent instructions interpretable by the target device;

processing the content element data of each content element by:
resizing any content element data which is visual content data of the rich content element based on at least one screen dimension of the target device, and
compressing the content element data; and

providing the translated instructions and processed content element data for each rich content element in a data file that will enable the rich content to be appropriately rendered on the target device.

According to another aspect there is provided A formatting and conversion system comprising:

an interpreter which reads a rich content source file to obtain formatting instructions and content element data for each rich content element and for each rich content element appropriately calls:
a translator to translate formatting instructions of the rich content element into small footprint equivalent instructions interpretable by a given target device; and
a data file converter to resize any content element data of the rich content element which is visual content data based on at least one screen dimension of the target device and compressing the content element data of the rich content element.

Another aspect provides a method of optimizing rich content for transmission and reproduction on a target device. The method of this aspect includes obtaining a structured document comprising at least one content element, wherein at least one of the content elements is a rich content element, translating text-based formatting instructions of the rich content element into numerical-based formatting instructions interpretable by the target device, and processing at least one of the content elements by resizing at least one item of the content element which is visual content data based on at least one screen dimension of the target device, and compressing the visual content data. The method of this aspect further includes providing the translated instructions and processed content element for each rich content element in a data file that will enable the structured document to be rendered on the target device.

Another aspect provides a formatting and conversion system. The system of this aspect includes an interpreter configured to read a rich content source file to obtain formatting instructions and content element data for at least one rich content element, a translator configured to translate text-based formatting instructions of the rich content element into numerical-based formatting instructions interpretable by a given target device, and a data file converter configured to resize the at least one rich content element which is visual content data based on at least one screen dimension of the target device and compressing the content element data of the rich content element.

Another aspect provides a system for optimizing rich content for transmission and reproduction on a target device. The system of this aspect includes means for obtaining a structured document comprising at least one content element, wherein at least one of the content elements is a rich content element, means for translating text-based formatting instructions of the rich content element into numerical-based formatting instructions interpretable by the target device, and means for processing at least one of the content elements by resizing at least one item of the content element which is visual content data based on at least one screen dimension of the target device, and compressing the visual content data. The system of this aspect further includes means for providing the translated instructions and processed content element for each rich content element in a data file that will enable the structured document to be rendered on the target device.

Another aspect provides a computer readable medium comprising programming instructions that upon executing cause a machine to obtain a structured document comprising at least one content element, wherein at least one of the content elements is a rich content element, translate text-based formatting instructions of the rich content element into numerical-based formatting instructions interpretable by the target device, process at least one of the content elements by resizing at least one item of the content element which is visual content data based on at least one screen dimension of the target device, and compressing the visual content data, and provide the translated instructions and processed content element for each rich content element in a data file that will enable the structured document to be rendered on the target device.

Another aspect provides a method, comprising parsing a first structured document, wherein the first structured document comprises a plurality of tags, and wherein at least one of the tags references a second structured document, retrieving the second structured document; generating a third document integrating the first structured document and the second structured document, wherein generating comprises modifying the tag in the first structured document to physically include the referenced second structured document, and transmitting the generated third document via a wireless network to a target device.

Another aspect provides a system including an interpreter configured to parse a first structured document, wherein the first structured document comprises a plurality of tags, and wherein at least one of the tags references a second structured document, and retrieve the second structured document, a data file converter configured to generate a third document integrating the first structured document and the second structured document by modifying the tag in the first structured document to physically include the referenced second structured document, and a transmitter configured to transmit the generated third document via a wireless network to a target device.

Another aspect provides a system including means for parsing a first structured document, wherein the first structured document comprises a plurality of tags, and wherein at least one of the tags references a second structured document, means for retrieving the second structured document, means for generating a third document integrating the first structured document and the second structured document, wherein generating comprises modifying the tag in the first structured document to physically include the referenced second structured document, and means for transmitting the generated third document via a wireless network to a target device.

Another aspect provides a computer readable medium comprising programming instructions that upon executing cause a machine to parse a first structured document, wherein the first structured document comprises a plurality of tags, and wherein at least one of the tags references a second structured document, retrieve the second structured document, generate a third document integrating the first structured document and the second structured document, wherein generating comprises modifying the tag in the first structured document to physically include the referenced second structured document, and transmit the generated third document via a wireless network to a target device.

Another aspect provides a method including obtaining a profile of a target device, the profile indicating a screen size in pixels, parsing a first structured document, wherein the first structured document includes at least one visual content element, rendering at least one the visual content elements, resizing of the rendered visual content element to a pixel size that is compatible with at least one dimension of the screen size of the target device profile, generating a second document including the resized visual content element, and transmitting the generated second document via a wireless network to the target device.

Another aspect provides a system including an interpreter configured to obtain a profile of a target device, the profile indicating a screen size in pixels, parse a first structured document, wherein the first structured document includes at least one visual content element, and render at least one the visual content elements, a data file converter configured to resize the rendered visual content element to a pixel size that is compatible with at least one dimension of the screen size of the target device profile, and generate a second document including the resized visual content element, and a transmitter configured to transmit the generated second document via a wireless network to the target device.

Another aspect provides a system including means for obtaining a profile of a target device, the profile indicating a screen size in pixels, means for parsing a first structured document, wherein the first structured document includes at least one visual content element, means for rendering at least one the visual content elements, means for resizing of the rendered visual content element to a pixel size that is compatible with at least one dimension of the screen size of the target device profile, means for generating a second document including the resized visual content element, and means for transmitting the generated second document via a wireless network to the target device.

Another aspect provides a computer readable medium comprising programming instructions that upon executing cause a machine to obtain a profile of a target device, the profile indicating a screen size in pixels, parse a first structured document, wherein the first structured document includes at least one visual content element, render at least one the visual content elements, resize the rendered visual content element to a pixel size that is compatible with at least one dimension of the screen size of the target device profile, generate a second document including the resized visual content element, and transmit the generated second document via a wireless network to the target device.

An advantage of embodiments is that formatting and control instructions for rich content are replaced by small footprint numeric format and control instructions readable by the target device, which reduces the total number of bits required for rendering the rich content on the target device. Where necessary content is also re-sized for a target device screen and further compressed to minimize the total number of data bits to be transferred between the content provider and the mobile device. This can result in up to 90% of the total number of bits for a web page being removed before transmission of the rich content to a target device while still enabling the web page to be rendered in a usable form on the target device.

Further, re-sizing content such as images or video for the target mobile device reduces the amount of processing required of the mobile device to render the content for viewing on the device screen once the data is downloaded as any content is already optimized for display on the mobile device. The resizing also allows resizing for large screen TV displays.

Content throughout this specification refers to information available as data from an electronic source and can include rich content such as available from an internet web site including graphically formatted textual information, images, animations, video and audio data. Content can also include information enabling accessing of further content such as links, URLs, or forwarding address information. One web page or one rich content file may include a plurality of rich content elements.

“Rich content element” refers to a segment of rich content which includes both content data and formatting instructions associated with the content data of the rich content element to define how the content data is rendered to a user. For example a rich content element may be formatted text, a picture or photograph, an advertisement, a sound track, an animation, a video clip etc.

“Visual content data” refers to any content data which is displayed to a user as still or moving visual images. For example, visual content data includes pictures, drawings, graphs or charts, maps, photographs, video clips, animated images or animations, computer generated graphical moving images etc.

“Formatting instructions” refers to instructions used to define how data will be rendered to a user. Formatting instructions used may depend on the type of data. For example where the content data is text, the formatting instructions may define color, font, bold, underlined, etc, where the content data is a visual image, formatting instructions may define whether the image is displayed in a border, whether the image is displayed in full color or black and white, or whether the image is animated so it appears as a moving image. Where the data is audio data, formatting instructions can include whether the audio data is to be played simultaneously with the display of a particular displayed image, when an action is performed, or whether the audio data is repeated a number of times. Formatting instructions come in may forms often dependent on the editor used to prepare the content. “Text based formatting instructions” refers to descriptive tag style instructions such as used in mark up languages, for example HTML, XML, SGML etc. “Text based tag form” or “text based instruction tags” are also used in this specification to refer to text based formatting instructions.

“Small footprint equivalent instructions” refers to a set of formatting instructions which have a numeric representation, also referred to as a bit level representation, which uses only a small number of bytes or bits for each instruction, such that the number of data bits used to represent these instructions is less than the equivalent instruction represented in a text based formatting instruction form such as HTML. The small footprint equivalent instructions can be represented using both an XML representation, for example to provide represent the instructions in an easily editable form to a user, or the numeric representation which is used in machine readable files.

Throughout the specification “target device” is used to refer to a plurality of different types of user devices. For example a target device can be a mobile phone, PDA, portable tablet computer, media player, game player or other device such as set top box & TV.

“Render” and “rendering” are used to refer to the reproducing or displaying the content as the content provider intended to the content to be perceived by the user on the user's equipment. For example rendering the content includes but is not limited to reproduction of audio signals as sound output by device speakers, the display of visual images on a display screen and the display of animated content as moving images on the display screen.

### BRIEF DESCRIPTION OF THE DRAWINGS

An embodiment, incorporating all aspects, will now be described by way of example only with reference to the accompanying drawings in which:

FIG. 1 is a block diagram of a system according to an embodiment.

FIG. 2 illustrates a process of formatting and compressing rich content in accordance with an embodiment.

FIG. 3 illustrates a process of formatting instruction translation in accordance with an embodiment.

FIG. 4 illustrates a process of data formatting in accordance with an embodiment.

FIG. 5a illustrates steps performed in a first pass of a compilation process to provide and editable version of a converted source file in accordance with an embodiment.

FIG. 5b illustrates steps performed in a second pass of a compilation process to produce a numeric data file optimized for a target device from an editable version of a converted source file in accordance with an embodiment.

FIG. 6 illustrates an example of adjusting positions of rich content elements in order to accommodate different target device display screen aspect ratios.

### DETAILED DESCRIPTION OF THE INVENTION

Embodiments a method and system for reducing the quantity of data used to reproduce rich content formatted for display, such as a web page, on a target device, by translating formatting instructions into a small footprint equivalent instruction format, resizing any visual content data appropriately for display on the target device screen, and compressing the translated and resized content data.

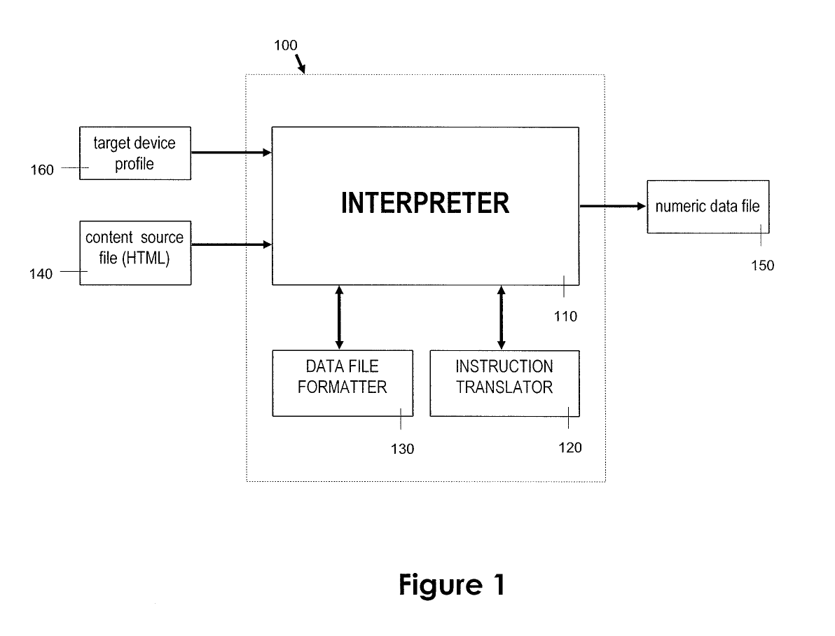

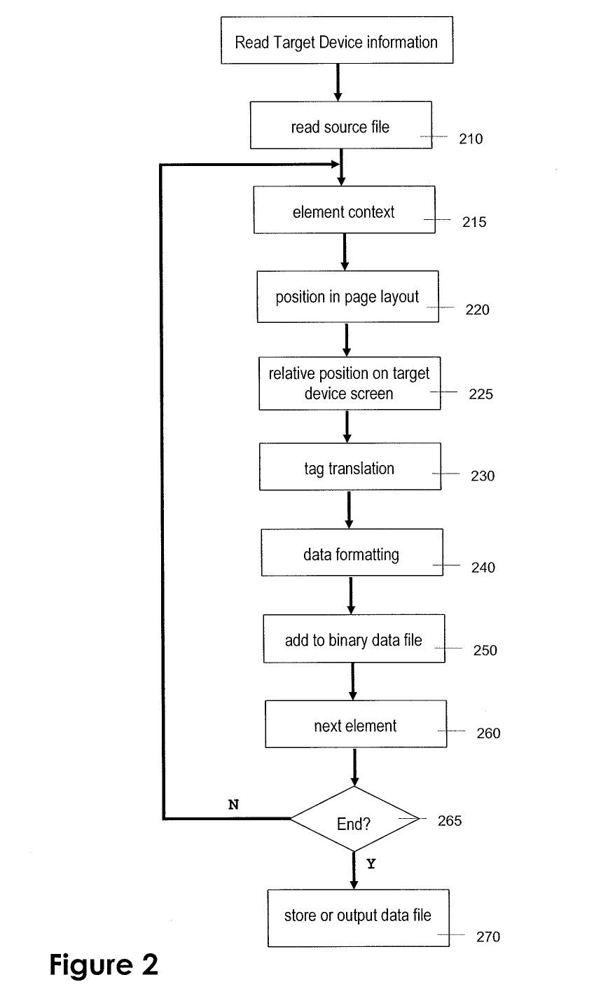

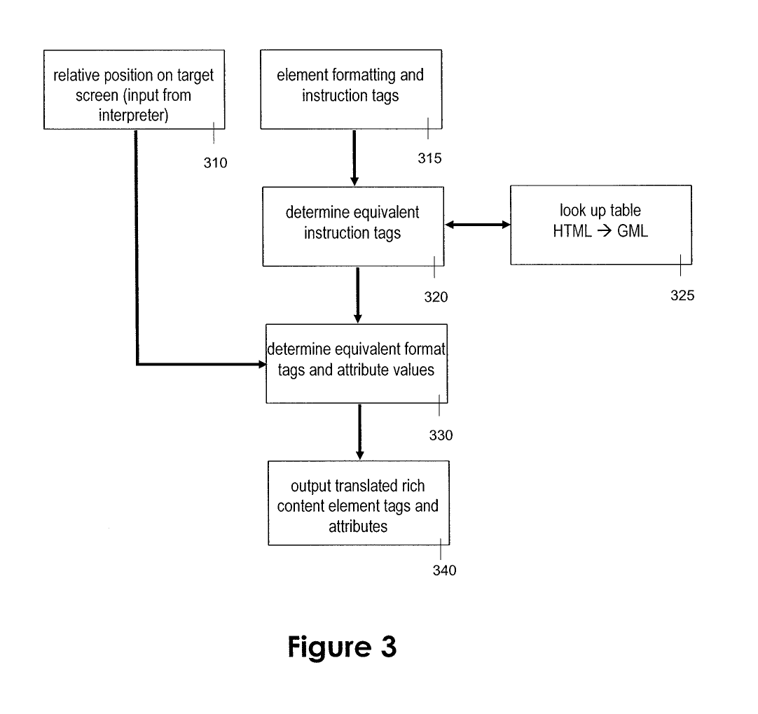

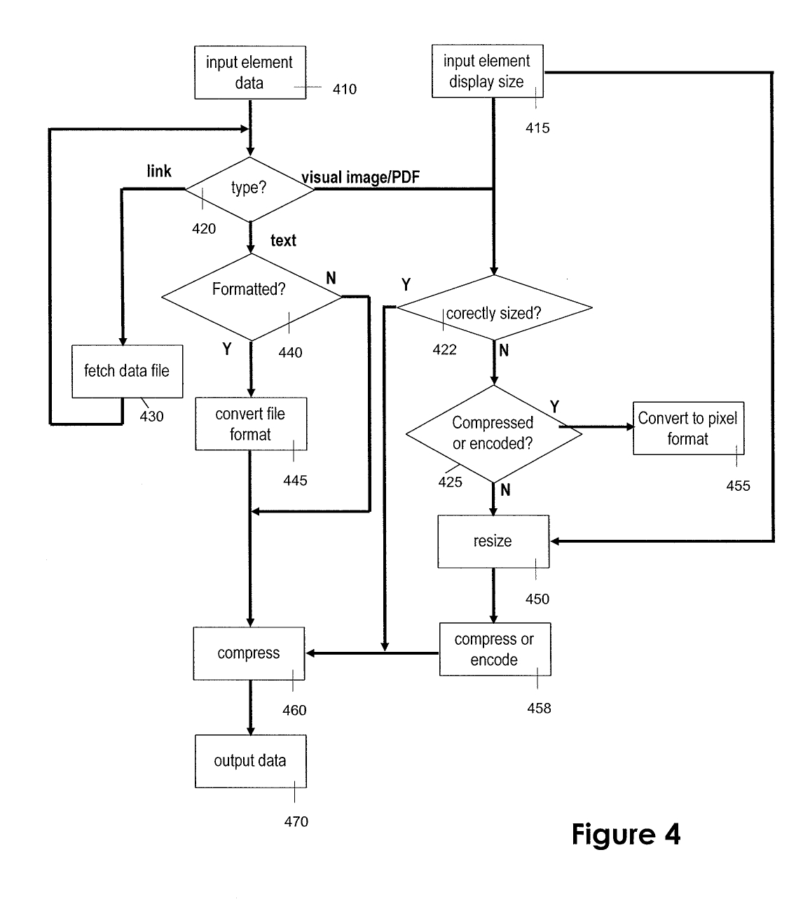

FIG. 1 is a block diagram of a system 100 according to an embodiment. The system 100 comprises an interpreter 110 an instruction translator 120 and a data file formatter 130. The interpreter 110 determines for each rich content element the position, where each content element should be located, and context, what each content element is and, where appropriate, its relationship to other content elements. The interpreter 110 calls the functions of the instruction translator 120 and file formatter 130 as appropriate, for each content element and provides necessary information to these functions to enable them to optimize the rich content for reproduction on the target device.

For example, consider a rich content source such as an Internet web page. The page may contain a number of different content elements, such as text, pictures or photographs, video clips, advertisements, animations, data entry fields such as search fields or purchase fields, and links to other pages often included embedded in another element, the page will generally also have an overall formatting style within which each element appears in a particular location on the page as defined by the web page designer.

Rich content, such as is presented on Internet web pages, is typically defined formatted using text based formatting instructions or tags known to person skilled in the art as mark up languages. Some of the most common mark up languages currently being used are HTML, XML, and SGML. Web pages designed with downloading to devices such as mobile phones may use languages such as MIDP, WAP, XML and MHTML. Mark up languages provide instructions regarding how the data is to be appear on the page and can also include instructions for providing visual effects such as automatically scrolling text or image slide shows. The advantage of these text based tag languages is they define what the format is to be rather than how the particular document editor or viewer achieves the formatting effect, which provides for wide editor compatibility and consistency of reproduction for documents prepared using such formatting languages.

However, a problem with all these mark up languages is that the text based tags result in a large overall data file size for the web page source file. For example, each tag comprises a number of text characters. Typically ASCII characters are used for text, thus each formatting instruction tag will be a number of bytes long.

Rich content can also be defined using proprietary document formats having proprietary formatting instructions interpretable by a proprietary editor or viewer, such as used by Microsoft Word™ or Microsoft PowerPoint™. Proprietary formats use an instruction set generally developed and defined by the document editor developer, and these instruction sets often change between editor versions. Documents developed using one editor can generally not be opened in another editor. Thus a target device may require a compatible document editor or viewer installed to read the proprietary instruction set to render the data for the user. Alternatively the target device requires a document converter and viewer. Having to maintain multiple document editors, viewers and converters is cumbersome to a user and also the conversion of files from one format to another on the target device can cause delays or increased power consumption, which is particularly undesirable on a device such as a mobile device which typically has limited memory and processing capacity and runs on battery power.

To overcome such problems, proprietary document editors often include file format conversion functions to convert the file to an alternative format. For example, if the document is to be posted to a web site it will often be converted to a widely used text based formatting instruction tag format such as HTML. However, other formats such as portable document format (PDF) or common document editor formats, such as Microsoft Word™ format are commonly used. Where a document has been saved in an editable format, such as Microsoft Word™ or PowerPoint™, some embodiments are further adapted to convert the document format to a text based formatting instruction format such as HTML for input to the optimization process as described herein.

A tool commonly use by wed designers is to define a web page having an overall format, say defining a number of frames in which data can be displayed, and then link to data files to be display within each frame, resulting in a number of different data files being opened when displaying one web page. This has the advantageous effect that the content of a data file being linked to can be modified or the link changed to another data file without having to update the entire web page. Often the data files can be stored on a different source server to the web page server. Thus, a large quantity of data is transmitted when this source file and the data from linked files is accessed by a target device, such as a user's personal computer (PC), to reproduce the web page on the target device. The build process for reproducing the web page on the target device may require the target device to link to several different source files or servers to retrieve all the content data. This additional processing to obtain data from a number of files and servers is undesirable where the target device is a mobile device and the user may pay for the amount of data transferred and also the length of time the device is connected to the wireless network to download the data.

An embodiment uses a tag language where each formatting instruction tag is translatable into a small footprint equivalent instruction tag having a numeric representation of only a few bytes or bits to define the instruction tags and associated tag attributes. This minimizes the number of bits used to provide formatting and control instructions for the rich content. The small footprint equivalent instruction tag and attribute set of this embodiment is given in Example 1. An application, adapted to read the numeric tags as formatting instructions for rendering the content, is installed in the target device processor. The advantage of this small footprint equivalent instruction tag set is that the instructions are defined in a more data efficient manner using fewer bits, and thus a smaller data footprint, for the equivalent instruction compared to text based tags. Translating the text based formatting and control instructions into a small footprint numeric equivalent instructions is a first step in the optimization method.

Another step in the optimization method is resizing any visual content data appropriately for display on the target device. Any data elements which comprise visual images, such as photographs or videos, may not be sized appropriately for display on the target device screen. For example, the photographs from an internet web page designed for display on a PC may be too large for display on the screen of a mobile phone, whereas a short video taken using a mobile phone camera may be too small to be displayed appropriately on the full screen of a television without significant image processing to enlarge and sharpen the image. In the optimization method the display capability of the target device is taken into consideration and any visual content data resized appropriately for the target device before delivery of the rich content data to the target device.

In one embodiment resizing of visual content data is based on at least one of the height or width dimensions of the target device screen, given in pixels. A pixel is an information element defining a sample of an overall image. The target device has a screen having a fixed height and width, the resolution capability of the screen can be defined by the pixel density, thus a dimension of the screen can also be measured in number of pixels. In this embodiment an image or video file in pixel format is resized in accordance with a given pixel count for one dimension while maintaining the aspect ratio, ratio of height to width, of the image. The resizing of the image may either reduce or increase the number of pixels in the image depending on the target device. The resized pixel image can then be compressed using a compression algorithm suitable for the target device to reduce the data file size. The advantage of resizing the image prior to compression is that the image will be appropriately sized for the target device once it is decompressed, thus reducing the amount of processing performed by the target device to appropriately display the image.

Prior to the resizing step the visual content data may be converted from an encoded or compressed format to a pixel format. For example a video file may be stored in MPG4 format, the image reconstructed from the MPG4 format file will have a given pixel count, generally that of the original image before the MPG4 compression. Thus, an image directly reconstructed from the MPG4 file and displayed on the target device may not be correctly sized for the device screen, or require further processing in the target device to resize the image before display. This further processing may cause a delay or increased power consumption in the target device.

In an embodiment where a content element includes an encoded or compressed visual content data file, the visual content data is first reconstructed from the compressed or encoded format to a pixel image format, the pixel image is then resized appropriately for a given pixel count for at least one image dimension, the resized image is then re-encoded or re-compressed using either the same or another encoding or compression scheme. This encoding can also be a mathematical conversion directly from the existing format to the same or a different format including a reduction in the pixel count or image display size.

In an embodiment this visual content data resizing and compression is performed by the data file formatter 130.

In some embodiments each translated, resized and compressed rich content element of the content data is consolidated into a single data file for transmission and display on a target device. Preferably this data file is prepared such that the processor of the target device processes each instruction consecutively, for example reading the data file from start to finish and acting on each instruction as it is encountered in order to render the rich content for reproduction on the target device in a single processing pass. Thus, the rendering of the content on the target device is efficient, without requiring jumping between different addresses in the data file or opening other content data files. An advantage of this embodiment is that the processing time and power consumed by the target device is minimized by providing the content data file in an optimized form for reproduction on the target device. Further, the optimized data file minimizes the amount of data that is discarded during the rendering process on the target device. In some embodiments web or e-mail content many be contained in a first file and an advertisement may also be contained in the same file, appended to the web or e-mail content. In this embodiment the advertising content will be rendered from the file along with the web or e-mail content. In another embodiment the web or e-mail content comprises a first file and an advertisement that is associated with the web or e-mail content comprises a second file that is also loaded and displayed as part of the same function to display content, such that the content of both the first and second files is rendered for concurrent display on the device display screen.

When a web page is compiled, say to HTML source code, the overall formatting style and layout instructions to be used for the various content elements are defined in an initialization or header portion of the source data file. The rich content source code 140 and profile information 160 regarding the target device, such as the target device screen size (e.g., in pixels) and resolution (e.g., pixels/inch), are obtained and input to the interpreter 110. The profile information 160 may be transmitted by the target device directly to the interpreter or the may be obtained by the interpreter in some other manner (e.g., from a database containing user profile information provided at a time of registration). The interpreter 110 reads the rich content source code 210 and for each rich content element determines the content element context 215, which includes what the content element is and any defined relationship between the content element and other content elements, for example if two search fields should be displayed together. The interpreter 110 also determines the content element's position 220 within the web page layout, for example whether the content element is to appear at the top of the page and if necessary its location relative to another element for display, such as two related search fields to be displayed one above the other. Using this information the interpreter 110 determines the appropriate position 225 for the content element on the target device screen, based on the position within the web page layout.

The interpreter 110 passes the position information along with the formatting instructions for the content element to the tag translator 120. The translator translates 230 any formatting or instruction tags (HTML tags) along with the position information into equivalent small footprint instructions, in some embodiments of the system the translator converts the formatting and instruction tags directly into a numeric format.

Where the rich content element is a data file or link to a data file the interpreter calls the data file formatter 240 to appropriately re-format the data, which is then added 250 into the converted file with the translated tags for the content element and the interpreter continues to convert the next rich content element 260. The process is then repeated for the next rich content element 215 until the end of source file is reached 265. The rich content file is now in the form of a numeric data file 150. The numeric data file 150 is then output to the target device or stored 270 ready for download.

The functions performed by the formatter depend on the data file type, for example the formatter may perform any one or more of the following steps: resizing image content for the target device screen dimensions, fetching content data from a linked data file, conversion of data file formats, or data file compression. The actions taken by the formatter are dependent on the type of data for the rich content element.

An example of the actions taken by the formatter 130 and translator 120 will be described in further detail with reference to an example of a weather update being formatted for delivery to a mobile phone. The weather update may be accessible through an internet web page. The mobile phone user may have the URL for the weather update stored on their mobile phone when the user subscribes to the weather update service, the user may also provide profile details for their mobile phone, such as the screen size and resolution, to the weather update service when they subscribe. An application running on the web site server includes an embodiment of the interpreter, formatter and translator of the system. The weather update is prepared as part of the weather web site content in a HTML format. The posting of the new weather update in this embodiment triggers the application in the web server to prepare a copy of the content for downloading by the weather update service subscribers. The interpreter reads the HTML source for the web site and from within this source identifies the subscribed content elements, for example the “current conditions” and “forecast”. The interpreter identifies the two rich content elements as comprising formatted text data and also determines that maintaining of the position of these from the web site, for example at the top of a right side bar of the web page, is not necessary for the reproduction on the target device. This lack of a location restriction is based on the information from the user subscriptions and can be as simple as a flag indicting that only two content items are subscribed to and therefore the reproduction on the target device is independent of the web page screen location. The interpreter reads 210 the source code for the web site and identifies the first element of the subscribed content 215, the content in the weather update frame of the web site. The interpreter recognizes the position in the web page layout as irrelevant in this instance and therefore indicates 310 that the first element, the heading “Conditions for Sunnyvale” will be drawn at the top of the screen. The interpreter also provides information regarding the general web page style formatting 315 such as color schemes for the tag translator to use for color formatting if necessary. For example the tag translator uses this information to define the background color for the weather screen. In this embodiment the tag translator determines 320 the equivalent small footprint instruction tags and attributes therefore for the HTML tags using a look up table 325 of small footprint equivalent formatting instructions to determine the tag equivalents, the lookup table can include interpretation functions to recognize abbreviations or unusual HTML tags. Once the equivalent small footprint instruction tag and attributes have been determined the translator determines attribute values to be applied 330 for example, text color and size codes. The translated tags and attributes are then stored in the converted data file 340, this can be the numeric representation of the small footprint formatting instruction tags and attributes.

Where the data is plain text data, this is simply inserted into the converted data file with the translated tags. However, where the data is an image file or a link to a data file, the data file formatter is called to fetch the data file and determine whether any further formatting is necessary. The input element data 410, for example the data file location or link to the data file is input to the formatter. The formatter determines the data type 420. Where the data is a link to a data file stored on another source 430 the data file is fetched from that source and the type of data file is checked. If the data file is plain text data, the 440 the text is optionally compressed 460 and inserted in line with the formatting and instruction tags 470.

Where the file type is visual content data, for example an image file or video file, the formatter checks 422 whether the visual content data is sized for the display of the target device, for example based on the image dimensions and the size of the target device screen, optionally the formatter can also take the aspect ratio of the image into consideration. In an embodiment where the target device is a mobile phone, the formatter only considers one dimension, the display screen width for determining whether the image is sized for display on the target device, this is because most mobile phone users are comfortable with scrolling up content up and down to view it on the device screen. The formatter is provided with the pixel count 415 of the width of the target device display screen, the pixel count being the maximum number of pixels in one line across the display screen. The formatter determines based on the pixel count for the given dimension whether the image is correctly sized for display on the target device, for example if the pixel counts do not match, then the image will be resized either up or down to match the pixel count of the target device 450. Before performing the resizing the formatter checks 425 whether it is necessary to first decode or decompress 455 the image from the format used in the image file, for example JPEG or MPG4, to a pixel image. If the visual content data file is in a compressed or encoded state the visual content data can be reconstructed 455 to a pixel image. The resizing to the target pixel count 450 is then performed. The resizing 450 maintains the aspect ratio of the original image. The resized image may then be compressed or encoded 458 using the original or another compression or encoding format. The image data, may be both compressed or encoded 458 using a first algorithm and then further compressed 460 using an other algorithm 460 and inserted in line in the output data file 470. The resizing function may also reformat the image and enhance the image for a screen larger than the original target. For example, in the case of a JPEG image designed for a 800×640 screen where the target device display is a 2048 HDTV screen, the image may be reformatted to enable additional data to be added to enable the aspect ratio to be adjusted and the image to be enhanced for this larger screen size.

Using embodiments, rich content can be converted directly to a re-formatted and compressed numeric file for rendering on a target device. However some embodiments also provide a content editor which enables a source file to undergo formatting instruction translation conversion to convert the source document style formatting and instructions into an XML representation of the small footprint formatting and instruction tags, enabling a user to edit the translated file. Alternatively a file can be generated using the XML object representation of the small footprint instructions.

In this embodiment in a first conversion pass to produce an editable version of the source code with formatting instructions converted to XML objects, for example as shown in Example 1, the interpreter calls the translator to convert the formatting instructions only, and does not reformat any content data for a target device. Indeed for such as conversion to or generation of an editable file format using an XML representation of the numeric instruction tags the target device may not be known. For example for rich content which is targeted to mobile phone users, such as advertisements, it may be desirable to prepare the rich content directly using the XML object version of the small footprint instructions to minimize conversion time.

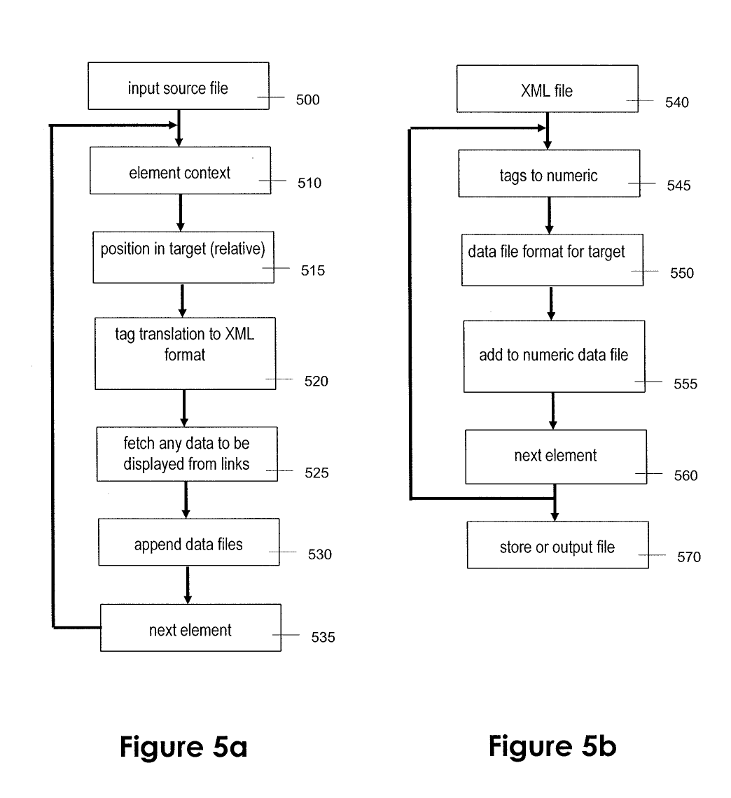

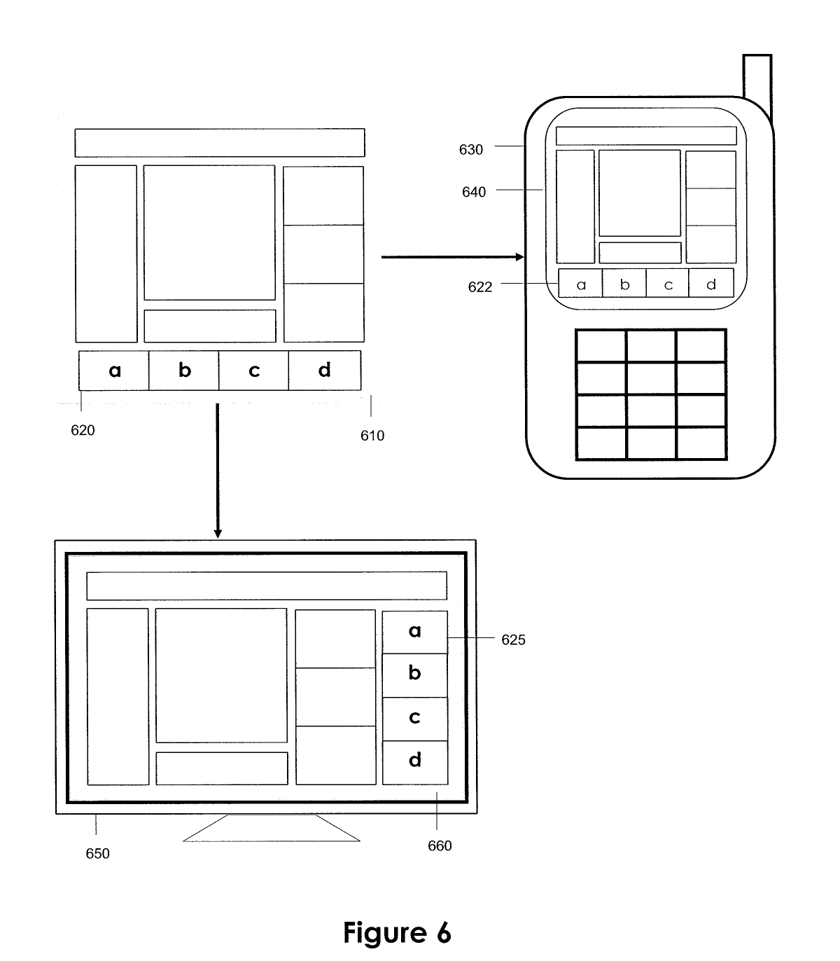

For example, as illustrated in FIG. 5a, on the first pass the source file is read 500 and for each element the context is determined 510 and the relative position 515 for the element on the target device screen determined. The formatting and instruction tags are then translated 520 to the equivalent small footprint tags and represented as XML objects. Optionally any data from external sources, such as file servers or other web servers, is fetched 525 and visual content data files may optionally be decompressed or decoded to a pixel image format ready for resizing, if necessary. Any fetched data files or images can be appended as data files 530 linked in the XML object for that element. The next element 535 is then read and the process continues until the whole of the input source is converted.

An example of a section of the translated content source file in XML is give below:

Weather Alert

```
<gui color=“255 255 255”>
    <txt face=“2” style=“1” color=“10 10 120”>Conditions for
    Sunnyvale, CA at 8:56 am PST</txt>
    <n />
    <img pos=“left” src=“http://us.i1.yimg.com/us.yimg.com/i/us/we/52/
    34.gif” />
    <txt face=“2” style=“1” color=“10 10 120”>Current
    Conditions:</txt>
    <txt face=“1” style=“1” color=“10 10 120”>Fair, 17 C</txt>
    <txt face=“2” style=“1” color=“10 10 120”>Forecast:</txt>
    <txt face=“1” style=“1” color=“10 10 120”>Mon -
    Partly Cloudy. High: 21 Low: 12</txt>
    <txt face=“1” style=“1” color=“10 10 120”>Tue -
    Partly Cloudy. High: 20 Low: 12</txt>
</gui>
```

Once the target device display dimensions are specified a second conversion pass can be performed, to convert the XML objects to numeric instruction format and also resize, convert and compress any data files.

An example of the second pass is illustrated in FIG. 5b. Each XML object 540 for each element is read and the tags converted to numeric format 545 and the data associated with the element formatted for the target device 550, this can include the resizing of image content and compression of the data, and the element data placed in line with the numeric element data tags 555. The next element 560 is then similarly read and processed until the whole file in converted. The converted file is then stored or output to the target device 570.

When compiling the rich content source to numeric format, options may be provided to enable the position of content elements to be adjusted suitably for the target device, for example menu 620 displayed as a bottom banner for a web page 610 may remain a bottom banner 622 where the target device is a mobile phone 630 but its position be altered to become a side banner 625 where the target device is a wide screen digital TV 650 due to the different aspect ratios of the mobile phone 630 display 640 compared to the TV 650 display screen 660 and scrolling capabilities of the displays for the two target devices. Options may enable the interpreter to automatically identify one or more content elements to for which the relative position may be adjusted to suit the aspect ratio of the target device display. For example, the position adjustment may be based on element type, such as advertisement or menu, or based on element size and relationship between content elements. Alternatively, any adjustable content elements and their position options may be indicated by the content designer.

A content editor may be provided with a compiler and pre-viewer to enable the designer to enter information about the target device, such as a device profile or screen dimensions, for the rich content to be re-formatted and then rendered in the pre-viewer to demonstrate how the content will be rendered on the given target device. Such a pre-viewer may be provided as a formatter application, say to enable a web site designer to preview how the web site HTML source file will be rendered on a target device, however, all editing is done on the original HTML source. Alternatively, the pre-viewer may be included in a suite of editing or development tools which enable the designer to edit the content.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### EXAMPLE 1

### Tags:

| | Numeric | | |
|---|---|---|---|
| TAG | Tag | | |
| NAME | Name | Description | XML Representation |
| Ads | 0x00 | advertisement. specifies an | <ads pos=“” delay=“”> |
| | | advertisement content and includes | <frame src =“‘ link=’”/> |
| | | a pointer to its location | </ads> |
| Anm | 0x10 | animation. specifies and points to | <anm pos=“” delay=“”> |
| | | the location of an animated image | <frame src=“” /> |
| | | | </anm> |
| Btn | 0x20 | button. defines a “push button” | <btn type=“” img=“” label=“” link=“”> |
| | | | <ref id=“”/> |
| | | | </btn> |
| Frame | 0x30 | frame. defines the frame of an | <frame scr=“” link=“” /> |
| | | element | |
| Grp | 0x40 | group. specifies the spatial | <grp color=“”> |
| | | rendering of a pair of elements. | <txt color=“” face=“” link=“” |
| | | There are four possible elements | style=“” value=“”“”/> |
| | | but only two are allowed for each | <img src=“” pos=“” link=“”/> |
| | | specified group | <ads pos=“”delay=“”> |
| | | | <frame src=“” link=“”/> |
| | | | </ads> |
| | | | <anm pos=“” delay=“”> |
| | | | <frame src=“”/> |
| | | | </anm> |
| | | | </grp> |
| Gui | 0x50 | gui.defines the container or field | <gui icon=“” color=“” label=“” type=“” |
| | | where the container where different | to=“” from=“”/> |
| | | components are added | |
| Img | 0x60 | image. specifies and points to the | <img src=“” pos=“” link=“”/> |
| | | location of an image file | |
| N | 0x70 | line. indicates a new line | <n/> |
| S | 0x80 | separator. defines a horizontal | <s width=“” color=“”/> |
| | | border | |
| Ref | 0x90 | reference. specifies id values | <ref id=“” /> |
| Snd | 0xA0 | audio. specifies and points to the | <snd format=“” loop=“” src=“”/> |
| | | location of a sound file | |
| Txt | 0xB0 | text. specifies text characteristics | <txt color=“” face=“” link=“” style=“” |
| | | | value=“”/> |
| Txtbox | 0xC0 | text box. defines an input field | <txtbox label=“” id=“” constraint=“” |
| | | where data can be entered | value=“” maxsize=“”/> |
| Vid | 0xD0 | video. specifies and points to the | <vid src=“” loop=“” url=“”/> |
| | | location of a video file | |

### Attributes:

### Tag=ads

| | Numeric | | |
|---|---|---|---|
| ATTRIBUTE | Attribute | | |
| NAME | Name | Possible Values | Numeric Equivalent |
| delay | 0x00 | 0–65535 (2bytes) | value in milliseconds |
| pos | 0x01 | left (default) | 0x00 |
| | | center | 0x01 |
| | | right | 0x02 |

| | Numeric |
|---|---|
| Child Tag | Equivalent |
| frame | 0x30 |

| Child Tag | Numeric | | |
|---|---|---|---|
| Attribute | Equivalent | Possible Values | Numeric Equivalent |
| link | 0x00 | url | |
| src | NA | url | |

### TAG=anm

| | Numeric | | |
|---|---|---|---|
| ATTRIBUTE | Attribute | | |
| NAME | Name | Possible Values | Numeric Equivalent |
| delay | 0x00 | 0-65535 (2 bytes) | value in milliseconds |
| pos | 0x10 | left (default) | 0x00 |
| | | center | 0x01 |
| | | right | 0x02 |

| | Numeric |
|---|---|
| Child Tag | Equivalent |
| frame | 0x30 |

| Child Tag | Numeric | | |
|---|---|---|---|
| Attribute | Equivalent | Possible Values | Numeric Equivalent |
| src | NA | url | |

### TAG=btn

| | Numeric | | |
|---|---|---|---|
| ATTRIBUTE | Attribute | | |
| NAME | Name | Possible Values | Numeric Equivalent |
| img | 0x00 | url | |
| label | 0x10 | string | |
| link | 0x20 | url | |
| type | 0x30 | get | 0x00 |
| | | post | 0x01 |

| | Numeric |
|---|---|
| Child Tag | Equivalent |
| ref | 0x90 |

| Child Tag | Numeric | | |
|---|---|---|---|
| Attribute | Equivalent | Possible Values | Numeric Equivalent |
| id | 0x00 | | |

### TAG=grp

| | Numeric | | |
|---|---|---|---|
| ATTRIBUTE | Attribute | | |
| NAME | Name | Possible Values | Numeric Equivalent |
| color | 0x00 | 3 bytes + extra 5 b) | |
| | | RGB | |

| | Numeric |
|---|---|
| Child Tag | Equivalent |
| ads | 0x00 |
| anm | 0x10 |
| img | 0x60 |
| txt | 0xB0 |

### TAG=gui

| | | | |
|---|---|---|---|
| | Numeric | | |
| ATTRIBUTE | Attribute | | Numeric |
| NAME | Name | Possible Values | Equivalent |

| | | |
|---|---|---|
| color | 0x00 | 3 bytes + extra 5 bytes RGB |
| icon | 0x10 | url |
| from | 0x20 | text |
| label | 0x30 | text |
| to | 0x40 | text |
| type | 0x50 | url |

### TAG=img

| | Numeric | | |
|---|---|---|---|
| ATTRIBUTE | Attribute | | |
| NAME | Name | Possible Values | Numeric Equivalent |
| link | 0x00 | url | |
| pos | 0x10 | left (default) | 0x00 |
| | | center | 0x01 |
| | | right | 0x02 |
| src | NA | url | |

### TAG=s

| | | | |
|---|---|---|---|
| | Numeric | | |
| ATTRIBUTE | Attribute | | Numeric |
| NAME | Name | Possible Values | Equivalent |

| | | |
|---|---|---|
| color | 0x00 | 3 bytes + extra 5 bytes RGB |
| width | 0x10 | % of screen width |

### TAG=snd

| | Numeric | | |
|---|---|---|---|
| ATTRIBUTE | Attribute | | |
| NAME | Name | Possible Values | Numeric Equivalent |
| format | 0x00 | amr | 0x00 |
| | | midi | 0x01 |
| | | mmf | 0x02 |
| | | mp3 | 0x03 |
| | | ott | 0x04 |
| | | wav | 0x05 |
| loop | 0x10 | byte(o–255) | |
| src | NA | url | |

### TAG=txt

| | Numeric | | |
|---|---|---|---|
| ATTRIBUTE | Attribute | | Numeric |
| NAME | Name | Possible Values | Equivalent |
| color | 0x00 | 3 bytes + extra 5 bytes RGB | |
| face | 0x10 | proportional small | 0x00 |
| | | proportional medium | 0x01 |
| | | proportional large | 0x02 |
| | | system small | 0x03 |
| | | system medium | 0x04 |
| | | system large | 0x05 |
| | | monospace small | 0x06 |
| | | monospace medium | 0x07 |
| | | monospace large | 0x08 |
| link | 0x20 | url | |
| style | 0x30 | plain | 0x00 |
| | | bold | 0x01 |
| | | plain\|italic | 0x02 |
| | | plain\|underlined | 0x03 |
| | | plain\|italic\|underlined | 0x04 |
| | | bold\|italic | 0x05 |
| | | bold\|underlined | 0x06 |
| | | bold\|italic\|underlined | 0x07 |
| value | 0x40 | | |

TAG=txtbox

| | Numeric | | |
|---|---|---|---|
| ATTRIBUTE | Attribute | | |
| NAME | Name | Possible Values | Numeric Equivalent |
| constraint | 0x00 | decimal | 0x00 |
| | | emailaddr | 0x01 |
| | | numeric | 0x02 |
| | | password | 0x03 |
| | | phone number | 0x04 |
| id | 0x10 | | |
| label | 0x20 | text | |
| maxsize | 0x30 | numeric | |
| value | 0x40 | | |

### TAG=vid

| | | | |
|---|---|---|---|
| | Numeric | | |
| ATTRIBUTE | Attribute | | |
| NAME | Name | Possible Values | Numeric Equivalent |

| | | |
|---|---|---|
| src | NA | url |
| loop | 0x00 | byte(0–255) |
| url | 0x10 | url |

What is claimed is:

1. A method of optimizing rich content for transmission and reproduction on a target device, comprising:
obtaining a structured document comprising at least one content element, wherein at least one of the content elements is a rich content element;
translating text-based formatting instructions of the rich content element into numerical-based formatting instructions interpretable by the target device;
processing at least one of the content elements by:
resizing at least one item of the content element which is visual content data based on at least one screen dimension of the target device, and
compressing the visual content data; and
providing the translated instructions and processed content element for each rich content element in a data file that will enable the structured document to be rendered on the target device.

2. A method as claimed in claim 1 further comprising determining a relative location for rendering of the rich content element on the target device screen.

3. A method as claimed in claim 2 wherein the step of translating includes defining a position of the rich content element on the target device screen in the numerical-based formatting instructions.

4. A method as claimed in claim 3 wherein the defined position for each rich content element is defined as a relative position.

5. A method as claimed in claim 1 further comprising acquiring at least one of a horizontal or a vertical screen dimension of the target device before the resizing step.

6. A method as claimed in claim 5 wherein the screen dimension is measured in pixels.

7. A method as claimed in claim 6 wherein the step of resizing visual content data includes converting the visual content from a compressed format into pixel format data, reducing the pixel count for the pixel format data in accordance with at least one of a given horizontal or vertical pixel count while maintaining the visual content's original aspect ratio.

8. A method as claimed in claim 1 wherein the optimization is performed in two passes, wherein a first pass translates the formatting instructions into small footprint formatting instructions to provide a content source file in an editable format, and a second pass resizes and compresses the editable format file for the target device.

9. A method as claimed in claim 1 wherein the numerical based formatting instructions are binary format instructions.

10. A formatting and conversion system comprising:
an interpreter configured to read a rich content source file to obtain formatting instructions and content element data for at least one rich content element;
a translator configured to translate text-based formatting instructions of the rich content element into numerical-based formatting instructions interpretable by a given target device; and
a data file converter configured to resize the at least one rich content element which is visual content data based on at least one screen dimension of the target device and compressing the content element data of the rich content element.

11. A system as claimed in claim 10 wherein the interpreter is further configured to determine a relative location for rendering of each rich content element on the target device screen.

12. A system as claimed in claim 11 wherein translating formatting instructions includes defining a position of the rich content element on the target device screen in the numerical-based formatting instructions.

13. A system as claimed in claim 12 wherein the defined position for each rich content element is defined as a relative position.

14. A system as claimed in claim 10 wherein the interpreter provides at least one of a horizontal or a vertical dimension to the data file converter for use in resizing visual content.

15. A system as claimed in claim 14 wherein the dimension is measured in pixels.

16. A system as claimed in claim 15 wherein the resizing of visual content data includes converting the visual content from a compressed format into pixel format data, reducing the pixel count for the pixel format data in accordance with at least one of a given horizontal or vertical pixel count while maintaining the visual content's original aspect ratio.

17. A system as claimed in claim 10 wherein the interpreter performs two optimization passes, wherein in a first pass the translator translates the formatting instructions into small footprint formatting instructions to provide a content source file in an editable format, and in a second pass the data file converter resizes and compresses the editable format file for the target device.

18. A system as claimed in claim 10 wherein the numerical-based formatting instructions are binary format instructions.

19. A system for optimizing rich content for transmission and reproduction on a target device, comprising:
means for obtaining a structured document comprising at least one content element, wherein at least one of the content elements is a rich content element;
means for translating text-based formatting instructions of the rich content element into numerical-based formatting instructions interpretable by the target device;
means for processing at least one of the content elements by:
resizing at least one item of the content element which is visual content data based on at least one screen dimension of the target device, and
compressing the visual content data; and
means for providing the translated instructions and processed content element for each rich content element in a data file that will enable the structured document to be rendered on the target device.

20. A computer readable medium comprising programming instructions that upon executing cause a machine to:
obtain a structured document comprising at least one content element, wherein at least one of the content elements is a rich content element;
translate text-based formatting instructions of the rich content element into numerical-based formatting instructions interpretable by the target device;
process at least one of the content elements by:
resizing at least one item of the content element which is visual content data based on at least one screen dimension of the target device, and
compressing the visual content data; and
provide the translated instructions and processed content element for each rich content element in a data file that will enable the structured document to be rendered on the target device.

21. A method, comprising:
parsing a first structured document, wherein the first structured document comprises a plurality of tags, and wherein at least one of the tags references a second structured document;
retrieving the second structured document;
generating a third document integrating the first structured document and the second structured document, wherein generating comprises modifying the tag in the first structured document to physically include the referenced second structured document; and
transmitting the generated third document via a wireless network to a target device.

22. The method of claim 21, wherein the at least one tag is in one or more text based formatting languages and generating the third document further comprises reformatting the tag to a binary-based formatting language

23. A system, comprising:
an interpreter configured to parse a first structured document, wherein the first structured document comprises a plurality of tags, and wherein at least one of the tags references a second structured document, and retrieve the second structured document;
a data file converter configured to generate a third document integrating the first structured document and the second structured document by modifying the tag in the first structured document to physically include the referenced second structured document; and
a transmitter configured to transmit the generated third document via a wireless network to a target device.

24. A system, comprising:
means for parsing a first structured document, wherein the first structured document comprises a plurality of tags, and wherein at least one of the tags references a second structured document;
means for retrieving the second structured document;
means for generating a third document integrating the first structured document and the second structured document, wherein generating comprises modifying the tag in the first structured document to physically include the referenced second structured document; and
means for transmitting the generated third document via a wireless network to a target device.

25. A computer readable medium comprising programming instructions that upon executing cause a machine to:
parse a first structured document, wherein the first structured document comprises a plurality of tags, and wherein at least one of the tags references a second structured document;
retrieve the second structured document;
generate a third document integrating the first structured document and the second structured document, wherein generating comprises modifying the tag in the first structured document to physically include the referenced second structured document; and
transmit the generated third document via a wireless network to a target device.

26. A method, comprising:
obtaining a profile of a target device, the profile indicating a screen size in pixels;
parsing a first structured document, wherein the first structured document includes at least one visual content element;
rendering at least one the visual content elements;
resizing of the rendered visual content element to a pixel size that is compatible with at least one dimension of the screen size of the target device profile;
generating a second document including the resized visual content element; and
transmitting the generated second document via a wireless network to the target device.

27. The method of claim 26, wherein the first structured document contains at least one tag in one or more text based formatting languages and generating the second document further comprises reformatting the tags to a binary-based formatting language

28. A system, comprising:
an interpreter configured to obtain a profile of a target device, the profile indicating a screen size in pixels, parse a first structured document, wherein the first structured document includes at least one visual content element, and render at least one the visual content elements;
a data file converter configured to resize the rendered visual content element to a pixel size that is compatible with at least one dimension of the screen size of the target device profile, and generate a second document including the resized visual content element; and
a transmitter configured to transmit the generated second document via a wireless network to the target device.

29. A system, comprising:
means for obtaining a profile of a target device, the profile indicating a screen size in pixels;
means for parsing a first structured document, wherein the first structured document includes at least one visual content element;
means for rendering at least one the visual content elements;
means for resizing of the rendered visual content element to a pixel size that is compatible with at least one dimension of the screen size of the target device profile;
means for generating a second document including the resized visual content element; and
means for transmitting the generated second document via a wireless network to the target device.

30. A computer readable medium comprising programming instructions that upon executing cause a machine to:
obtain a profile of a target device, the profile indicating a screen size in pixels;
parse a first structured document, wherein the first structured document includes at least one visual content element;
render at least one the visual content elements;
resize the rendered visual content element to a pixel size that is compatible with at least one dimension of the screen size of the target device profile;
generate a second document including the resized visual content element; and
transmit the generated second document via a wireless network to the target device.
